(19) United States
(12) Patent Application Publication
(10) Pub. No.: US 2004/0153592 A1
(43) Pub. Date: Aug. 5, 2004

(54) Method for adapting a bus and a bus

(75) Inventors: Jari Parviainen, Jaali (FI); Timo Hamalainen, Kangasala (FI); Kimmo Kuusilinna, Tampere (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/735,052

(22) Filed: Dec. 12, 2003

Related U.S. Application Data
(63) Continuation of application No. PCT/FI02/00497, filed on Jun. 7, 2002.

(30) Foreign Application Priority Data
Jun. 13, 2001 (FI) 20011257

(51) Int. Cl. G06F 3/00; G06F 5/00; G06F 13/36; G06F 13/362

(52) U.S. Cl. 710/116; 710/117; 710/306

(57) ABSTRACT

A method for adapting a bus to data traffic in a system comprising several functional units (311, 312, . . . , 31n) and a bus structure. The functional units are divided into at least two sets so that units, which mainly transfer data with each other belong to a same set and are interfaced with the same separate sub-bus (321; 322). The sub-buses can be united by switches (SW) into a more extensive bus, which is only used when data must be transferred between different sets. Supply voltage of each sub-bus is adjustable and is set the lower the less traffic there is on the bus. The parallel transfer operation makes it possible to increase the transfer capacity of the bus structure without increasing it's clock frequency. Furthermore energy consumption can be reduced by dropping the supply voltage of the bus circuits so that the bus retains the transfer capacity needed.

The invention relates to a method for adapting a bus to data traffic in a system comprising several functional units. The invention further relates to a bus structure adaptable to data traffic. The method and bus structure are suitable to be applied especially in base stations and terminals of mobile communication networks.

### BACKGROUND OF THE INVENTION

Systems and apparatus having plenty of activities implemented in software are generally realized in a distributed manner such that for each essential type of activity there is one or more usually processor-based units. To transfer data between the units a bus is needed, interconnecting the units. The bus includes parallel lines for the data proper, address data and other control data. Each functional unit of course comprises a bus interface through which the bus can be utilized. Operation of the bus is inevitably based on time division. Time division, in turn, may in principle be asynchronous or synchronous. In the asynchronous case, an individual transfer may begin at any given moment, and in the synchronous case, an individual transfer may only occur in a given time slot. Time slots start at regular intervals, and the successive time slots form a broader, recurring time frame. In both cases, some kind of a bus management system is required to prevent transfers from overlapping.

From the prior art we know of several bus solutions which differ from one another in their details. FIGS. 1a,b and 2 show examples of known buses. FIG. 1a is a block diagram of a system comprising a bus 120 and in connection therewith, n functional units, such as functional units 111, 112 and 11n. Each functional unit includes a processing unit PU with its (bus) interface unit IU. FIG. 1b shows an example of the structure of the interface unit IU. It comprises a first-in-first-out type buffer memory FIFO OUT on the output side, a buffer memory FIFO IN on the input side, bus drivers BD, bus receivers BR, and a control unit CU for the interface unit. Both of the buffer memories serve as intermediate storages for data transferred through the bus. They can store a certain amount of consecutively transferred data words with the addresses associated therewith. In FIG. 1b the buffer memories are shown to be of the FIFO type, i.e. ones in which data is output in the same order as it was input. The buffer memories may also be usual memories with address registers. The processing unit in the functional unit in question controls the output-side buffer memory through the control unit CU. The output of the output-side buffer memory FIFO OUT is connected to the inputs of the bus drivers BD, and the outputs of these are connected to the data, address and control lines of the bus 120. The data, address and control lines of the bus are also connected to the inputs of the bus receivers BR. The outputs of the bus receivers are, as regards data and address, connected to the input of the input-side buffer memory FIFO IN and, as regards control lines, to the control unit CU. The latter handles transfers from the input-side buffer memory to the processing unit.

To transfer data through the bus the control unit may first issue a request for the bus. When the bus is available, the control units of the sending and receiving functional units perform a handshake in order to ensure that the receiving party is ready. After that, data are actually transferred. In order to make the transfer process faster, the “intelligence” of the control unit may be increased so that it is aware of the data transfer needs and priorities of the other functional units. The transfer system is configured such that a majority of the transfers occurs in predetermined time slots. Preliminary operations for the actual data transfer may thus be left out of the transfer process. Moreover, the number of lines needed in the control bus becomes smaller as compared to buses using the handshake. In order to provide timing for the send and receive operations the control unit gets a master sync signal via the bus from a frame synchronization unit.

FIG. 2 shows an example of data transfer on a bus in relation to the structure of FIG. 1. The transfer is based on synchronous time division: A recurring time frame consists of m successive time slots. Each processing unit is allocated at least one time slot for data transfer. In time slot 1 a first processing unit PU1 sends a data word to a second processing unit PU2. In time slot 2 the second processing unit PU2 sends a data word to a third processing unit PU3. In time slot 3 the third processing unit PU3 sends a data word to the second processing unit PU2. In the last time slot m a processing unit PUn sends a data word to a processing unit PU(n−1). Other data transfers may occur in time slots 4 to (m−1). At the beginning of the next frame, in time slots 1 to 3, there is repeated the same three-transfer sequence which occurred at the beginning of the preceding frame. Furthermore, in time slot m−1, a processing unit PU(n−1) sends a data word to the processing unit PU2.

In a simple case, the number of time slots in a frame is the same as that of functional units connected to the bus. In a particular frame it is also possible to allocate several time slots to a functional unit which has got a relatively large amount of data to be sent. Moreover, time slots may be reserved for occasional transfer needs.

As the number of activities in a system increases and the activities become more complicated, the transfer capacity of a bus specified in a certain manner becomes at a certain point inadequate, thereby resulting in congestion. This can be avoided by increasing the clock frequency of the bus so that more data can be transferred per time unit. Increase of the clock frequency may be considered a bus adaptation method according to the prior art. It involves, however, disadvantages in the form of increased power consumption and degradation of reliability of transfer. Moreover, the clock frequency has a certain top limit determined by circuit technology.

### SUMMARY OF THE INVENTION

An object of the invention is to reduce the aforementioned disadvantages related to the prior art. A method according to the invention is characterized in that which is specified in the independent claims 1 and 2. A bus structure according to the invention is characterized in that which is specified in the independent claim 7. Advantageous embodiments of the invention are specified in the other claims.

The idea of the invention is basically as follows: In a system comprising a plurality of functional units, the functional units are divided into at least two sets so that functional units which mainly transfer data with each other belong to a same set. The functional units of a set are interfaced with the same separate sub-bus. The sub-buses may be united by switches into a more extensive bus. The more extensive bus is only used when data must be transferred between functional units in different sets. The supply voltage of each sub-bus is adjustable and in order to save energy, it is adjusted according to the amount of traffic on the bus so that the less traffic, the lower the voltage.

An advantage of the invention is that it can be used to increase the transfer capacity of the bus structure without increasing the clock frequency of the bus. This is based on the parallel transfer operations provided by the sub-buses. Another advantage of the invention is that it can be used to reduce the energy consumption of a system. This happens when the extra capacity provided by the parallel transfer operations is not utilized but, instead, the supply voltage of the bus circuitry is decreased such that the bus retains the transfer capacity needed.

### BRIEF DESCRIPTION OF THE DRAWINGS

The invention is below described in closer detail. The description refers to the accompanying drawings where

FIG. 1a shows a system with a bus according to the prior art,

FIG. 1b shows an example of a bus interface,

FIG. 2 shows an example of data transfer through a bus according to the prior art,

FIG. 3 shows a system with an exemplary bus according to the invention,

FIG. 4 shows an example of data transfer through a bus according to the invention,

FIG. 5 shows a second example of data transfer through a bus according to the invention,

FIG. 6a shows in the form of flow diagram an example of the use of a bus according to the invention,

FIG. 6b shows in the form of flow diagram an example of energy saving according to the invention,

FIG. 7 shows a system with a second example of a bus according to the invention.

### DETAILED DESCRIPTION OF THE INVENTION

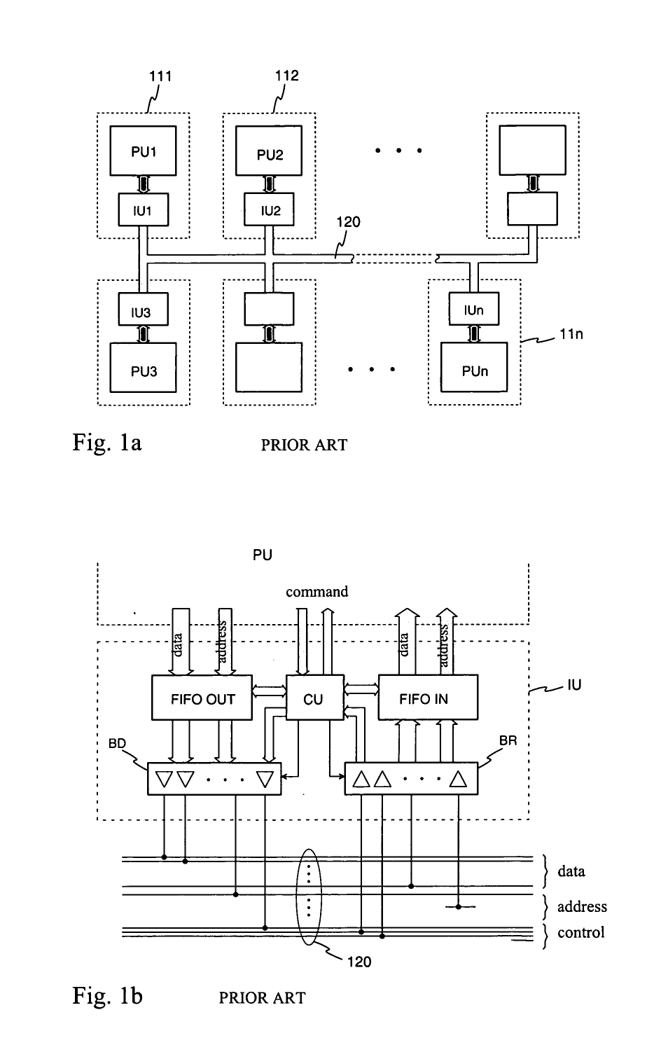

FIG. 3 is a block diagram of a system including an example of a bus according to the invention. The system comprises functional units, each of which includes a processing unit PU and a bus interface unit IU thereof. The difference from the structure of FIG. 1 is that the bus is now divided into two parts, a first sub-bus 321 and a second sub-bus 322. Interfaces with the first sub-bus are e.g. a first 311, second 312 and a third 313 functional unit, and to the second sub-bus e.g. the functional units 31u and 31n. Between the sub-buses there is a switching unit 330 which comprises a switching part proper SW and a switch control unit SCU. By means of the switching unit each line in the first sub-bus can be connected to the corresponding line in the second sub-bus. The sub-buses can thus be kept separate or they can be united. The functional units are grouped in such a manner that functional units interfaced with a particular sub-bus have a relatively large amount of mutual data transfer and, conversely, relatively little need to exchange data with a functional unit in the other sub-bus. For the most part of the time, therefore, the sub-buses can be kept separate, enabling simultaneous transfers in them.

Data transfers from one sub-bus to another via the switching unit may be in part pre-planned, in which case the switch control unit SCU arranges for the connection of the sub-buses in the time slots allocated for this purpose. The data is sent thereafter. The interface unit of the receiving functional unit takes the transferred data in memory on grounds of the address. If no time slot was allocated beforehand for the transfer, the interface unit of the sending functional unit indicates the need of transfer to the switch control unit via a control line. The switch control unit responds by notifying when a time slot comes which is free in both sub-buses. If such a transfer is about to be delayed too much, the switch control unit may expedite it through an exceptional arrangement.

The system of FIG. 3 further includes a power management unit PMU which in practice may be part of the main control unit of the apparatus in question. The power management unit includes e.g. the sub-bus supply voltage stabilizers and frame synchronization units. The latter get their clock signals e.g. from the system's main oscillator via frequency dividers. The power management unit is interfaced with the both sub-buses. It is aware of the data transfer needs of the different applications and it is also aware of the applications that are running at a given moment. On these premises the power management unit controls the supply voltages of the sub-buses. Decreasing the voltage will automatically decrease the bus clock frequency in chips produced using the CMOS (complementary metal oxide semiconductor) technology. Decreasing the clock frequency naturally results in reducing the transfer capacity. So, in principle, the supply voltage can be set such that the less traffic in a sub-bus, the lower the voltage. In practice the adjustment is made in steps, the number of voltage levels being at least two. The speed and energy consumption of a bus can be reduced by directly decreasing the clock frequency only. Energy consumption depends linearly on the clock frequency, but squarely on the supply voltage. So, decreasing the supply voltage is more advantageous, for then the energy consumption will drop drastically as the supply voltage drops and, furthermore, it will drop because the clock frequency is decreased as a consequence of the dropping of the supply voltage.

When the sub-buses 321 and 322 are united for data transfer between them, they may have different clock frequencies prior to the connection. However, both sub-buses have to retain frame synchronization over the transfer. The simplest way to ensure this is to mutually synchronize the clocks of the sub-buses. Transfer from a sub-bus to another is always started at a moment when a time slot is beginning in both sub-buses. The transfer takes place during the shorter of the two time slots.

The ratio of the lengths of the time slots may in principle be any ratio of integer numbers, 2:1 in the simplest case. If the clocks of the sub-buses are not synchronized, the power management unit may be provided with logic which e.g. lengthens the clock cycle of one sub-bus such that the data transfer will be kept within a single time slot in both sub-buses.

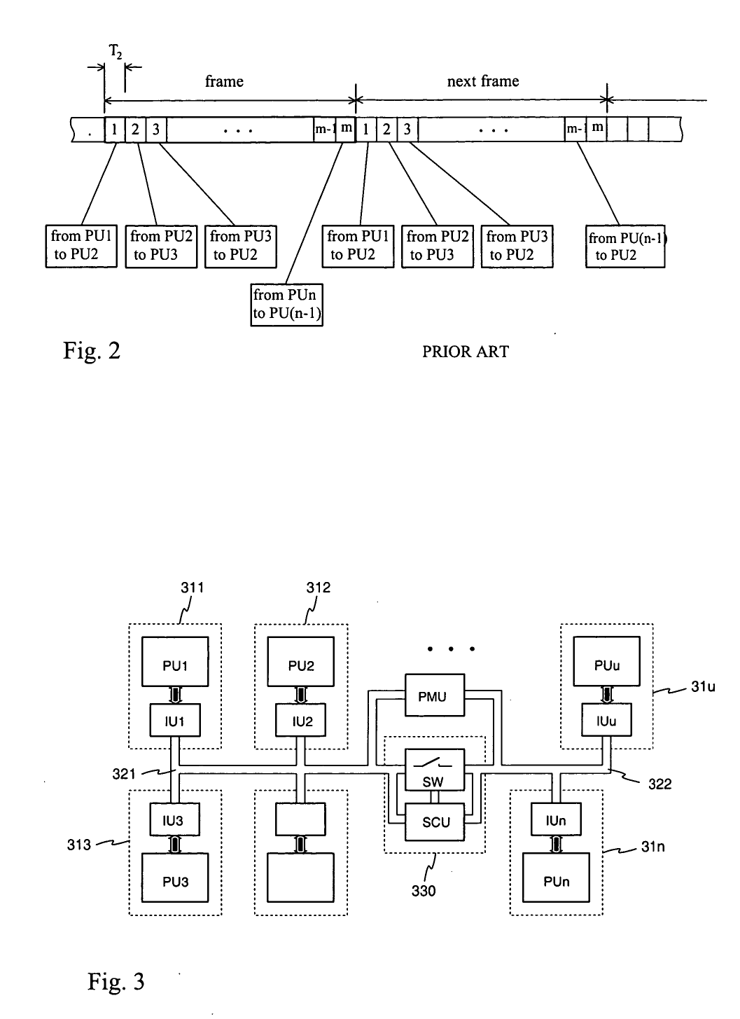

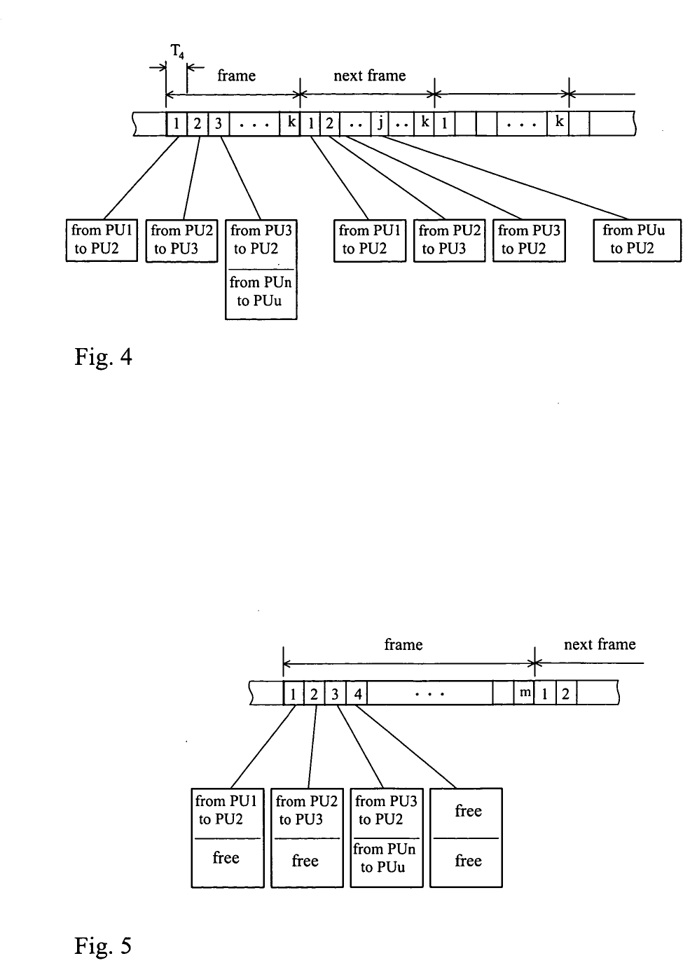

FIG. 4 shows an example of data transfer in a structure according to FIG. 3. The number k of time slots in the recurring time frame is now smaller than the number m of time slots in the frames of FIG. 2. The number k is e.g. a little over half of the number m. For comparison, this example involves the corresponding data transfers as FIG. 2. In time slot 1 of a certain frame, which is the first frame in FIG. 4, a first processing unit PU1 sends a data word to a second processing unit PU2, in time slot 2 the second processing unit PU2 sends a data word to a third processing unit PU3, and in time slot 3 the third processing unit PU3 sends a data word to the second processing unit PU2. Simultaneously in time slot 3 a processing unit PUn sends a data word to a processing unit PUu. This is possible because the processing units PU2 and PU3 are interfaced with a different sub-bus than the processing units PUu and PUn, and the sub-buses are separate from each other for at least the first three time slots. Other data transfers may occur in time slots 4 to k. At the beginning of the next frame, in time slots 1 to 3, there is repeated the same three-transfer sequence between the processing units PU1, PU2 and PU3 which occurred at the beginning of the preceding frame. In a time slot j the processing unit PUu sends a data word to the processing unit PU2. These two processing units are interfaced with different sub-buses. Therefore, the transfer is preceded by uniting the sub-buses in the switching unit.

In the example of FIG. 4 the transfer capacity of the bus structure increases compared to the example of FIG. 2 even because of parallel transfer operation if the bus clock frequency were the same in both cases. If the increased capacity is not needed, the structure according to the invention can be utilized by reducing power consumption as described earlier by dropping the bus supply voltage.

FIG. 5 shows a second example of data transfer in a structure according to FIG. 3. The number of time slots in the recurring time frame is now the same as in FIG. 2. In time slot 1 of a certain frame a first processing unit PU1 sends a data word to a second processing unit PU2 via a first sub-bus, and the second sub-bus is free. In time slot 2 the second processing unit PU2 sends a data word to a third processing unit PU3 via the first sub-bus, and the second sub-bus is free. In time slot 3 the third processing unit PU3 sends a data word to the second processing unit PU2 via the first sub-bus, and a processing unit PUn sends a data word to a processing unit PU(n−1) via the second sub-bus. Time slot 4 is free in both sub-buses. In this case, the division of the bus according to the invention means an increase in the number of free time slots.

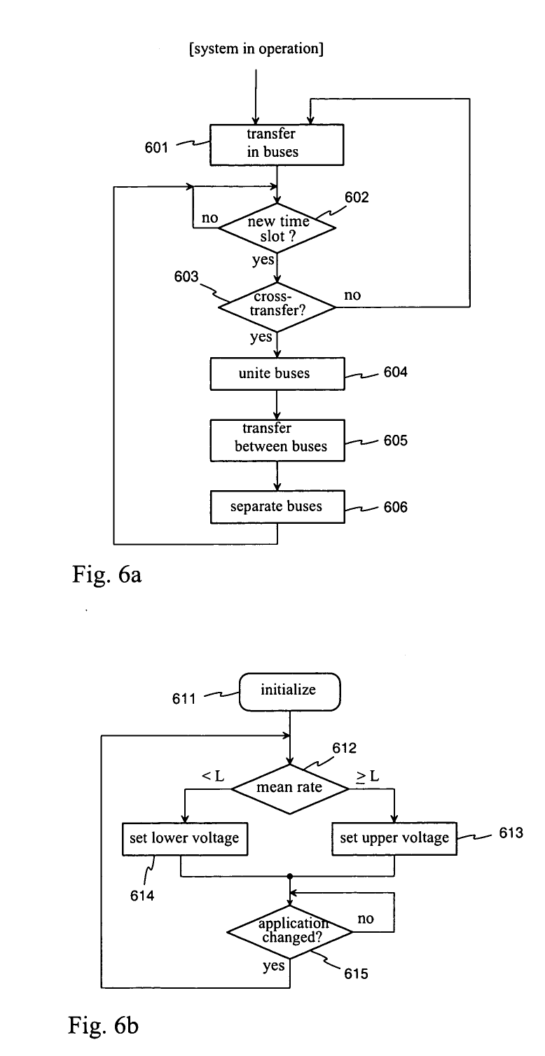

FIG. 6a is a flow diagram illustrating an example of a method according to the invention for using a bus. In step 601 a time slot of the frame system of the bus is elapsing. The time slot may involve data transfer in one or both sub-buses. In step 602 the beginning of the next time slot is awaited. In step 603 it is checked whether the next time slot involves data transfer across the switching unit from one sub-bus to the other. The control units of the functional units may already have information of this in the form of a table drawn up beforehand. If the transfer is not pre-planned, the decision on the transfer time slot is made by the switch control unit SCU. If there is no cross-transfer, the process returns to step 601. If the transfer from one sub-bus to the other is planned, the sub-buses are united in the switching part SW, step 604. Since the sub-buses may have different clock frequencies when they are separate, the connection takes place at a moment when a time slot is beginning in both sub-buses. It is assumed here that the clocks of the sub-buses are synchronized to one another. The non-synchronized case was also already discussed in connection with the description of FIG. 3. As soon as the sub-buses are united the data transfer takes place, step 605. After that, in step 606, the sub-buses are again separated. Operation continues in step 602.

FIG. 6b is a flow diagram illustrating an example of how energy is saved in a system according to the invention. In step 611 the system is initialized by informing the various control units of the data transfer needs and priorities of the functional units. This can be accomplished manually or automatically. In step 612 the power management unit PMU determines the mean transfer rate in the sub-buses, i.e. the amount of data transferred per time unit. This is done based on the nature of the applications running. If the result is greater than a certain value L, the supply voltage of the sub-bus in question is set to be the upper of two possible voltages (step 613). If the result is smaller than said value L, the supply voltage of the sub-bus in question is set to be the lower of two possible voltages (step 614). In step 615 it is checked whether a change has occurred among the applications running. If not, possible changes are awaited. If a change has occurred, the process returns to step 612. When the supply voltage is kept relatively low when the traffic allows, energy is saved as described above. The number of voltage levels used may of course be more than two.

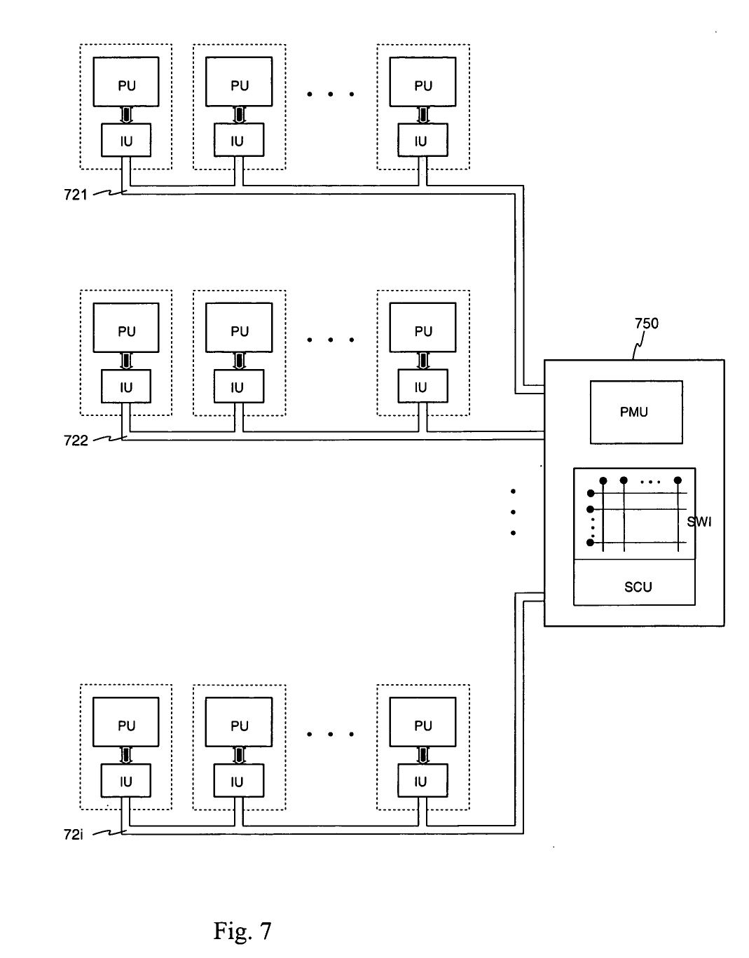

FIG. 7 shows a second example of a bus structure according to the invention. It comprises i sub-buses 721, 722, . . . , 72i. The sub-buses are interfaced with a switching unit which in this case is a matrix-shaped crossbar switch SWI. In the crossbar switch, each sub-bus can be connected to any other free sub-bus regardless of what earlier connections between sub-buses are on at that moment. The crossbar switch SWI, its control part SCU and the power management unit PMU make up the centralized part 750 of the bus system management.

Some solutions according to the invention were described above. The invention is not limited to those solutions only. The inventional idea may be applied in different ways within the scope defined by the independent claims.

1. A method for adapting a bus of a system to data traffic, which system comprises a plurality of functional units each having a processing unit and bus interface unit, between said functional units data being transferred through said bus in time slots recurring in accordance with a certain time frame, wherein said functional units are divided into at least two sets so that the functional units of a single set are interfaced with a separate sub-bus of their own, and said system further comprises a switching unit to unite different sub-buses into a more extensive bus, the method comprising steps, relating to individual time slot;
checking whether data has to be transferred across said switching unit from one sub-bus to another,
uniting the sub-buses in question if the result from the preceding step is positive,
separating the sub-buses in question again when the transfer, for which the sub-buses were united, is completed, and
keeping a particular sub-bus separated from the other sub-buses if there is no data transfer need therefrom across the switching unit in either direction.

2. A method for adapting a bus of a system to data traffic, which system comprises a plurality of functional units each having a processing unit and bus interface unit, between said functional units data being transferred through said bus, wherein said functional units are divided into at least two sets so that the functional units of a single set are interfaced with a separate sub-bus of their own and a supply voltage of the sub-bus is settable to at least two different levels, said system further comprising a switching unit to unite different sub-buses into a more extensive bus, the method comprising steps;
quantifying a mean data traffic rate for each sub-bus,
setting the supply voltage of a sub-bus to the lower one of said two levels if the data traffic rate of the sub-bus is smaller than a certain value.

3. A method according to claim 1, obtaining from a table drawn up beforehand an information about whether data has to be transferred in a certain time slot across the switching unit from one sub-bus to another.

4. A method according to claim 1 where the clock signals of the sub-buses are synchronized to one another, starting an uniting of two sub-buses at a moment when in both sub-buses a time slot is changing, to keep a data transfer within a single time slot in both sub-buses.

5. A method according to claim 1 where the clock signals of the sub-buses are not synchronized to one another, lengthening, if necessary, a clock cycle of one sub-bus to keep a data transfer within a single time slot in both sub-buses.

6. A method according to claim 2, quantifying the mean data traffic rate of a sub-bus on the basis of data transfer needs of application processes currently running in said system.

7. A bus structure of a system comprising a plurality of functional units each having a processing unit and bus interface unit, which bus structure is arranged to transfer data between the functional units in time slots recurring in accordance with a certain time frame,
wherein, to increase a transfer capacity of the bus, it comprises at least two sub-buses to each of which there is interfaced a set of said functional units, the bus structure further comprising a switching unit to unite said sub-buses into a more extensive bus and a power management unit to minimize energy consumption of the bus structure.

8. A bus structure according to claim 7, said power management unit comprising supply voltage stabilizers and frame synchronization units of said sub-buses.

9. A bus structure according to claim 7, said switching unit comprising a switching part and a switch control unit to unite sub-buses.

10. A bus structure according to claim 7, each of said functional units comprising a bus interface unit, which has a first buffer memory to store data and address information to be sent, a second buffer memory to store received data and address information and a control unit to store functional units' data transfer information and to arrange for the data transfers.

11. A bus structure according to claim 10, said first and second buffer memories being of the FIFO type.
